(19) United States
(12) Patent Application Publication
(10) Pub. No.: US 2024/0211290 A1
(43) Pub. Date: Jun. 27, 2024

(54) JOB SUBMISSION ALIGNMENT WITH WORLD SWITCH

(71) Applicants: ADVANCED MICRO DEVICES, INC., Santa Clara, CA (US); ATI TECHNOLOGIES ULC, MARKHAM (CA)

(72) Inventors: Yuping Shen, Orlando, FL (US); Min Zhang, Toronto (CA); Yinan Jiang, Richmond Hill (CA); Jeffrey G. Cheng, Markham (CA)

(21) Appl. No.: 18/088,955

(22) Filed: Dec. 27, 2022

(51) Int. Cl. G06F 9/455

(52) U.S. Cl. CPC G06F 9/45558; G06F 9/45545; G06F 2009/45579

(57) ABSTRACT

A processing system aligns rendering timing of an application executing at a guest virtual function to world switch timing of a host virtual machine. The host virtual machine sets a world switch interval based on a number of virtual functions (VFs) that share the parallel processor and a target maximum frame rate. The processing system delays submission of jobs for a VF to the parallel processor by an offset with respect to the world switch timing to ensure that the application starts generating a job for the parallel processor before the VF gains a time slice so the job will be ready for the parallel processor when the VF gains the time slice.

### BACKGROUND

Processing units such as graphics processing units (GPUs) and other parallel processors support virtualization that allows multiple virtual machines to use the hardware resources of the GPU. Each virtual machine executes as a separate process that uses the hardware resources of the GPU. Some virtual machines implement an operating system that allows the virtual machine to emulate an actual machine. Other virtual machines are designed to execute code in a platform-independent environment. A hypervisor creates and runs the virtual machines, which are also referred to as guest machines or guests. The virtual environment implemented on the GPU provides virtual functions to other virtual components implemented on a physical machine. A single physical function implemented in the GPU is used to support one or more virtual functions. The physical function allocates the virtual functions to different virtual machines on the physical machine on a time-sliced basis. For example, the physical function allocates a first virtual function to a first virtual machine in a first time interval and a second virtual function to a second virtual machine in a second, subsequent time interval. The single root input/output virtualization (SR-IOV) specification allows multiple virtual machines (VMs) to share a GPU interface to a single bus, such as a peripheral component interconnect express (PCIe) bus. Components access the virtual functions by transmitting requests over the bus.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system configured to align a job submission from a virtual function with a time slice assigned to the virtual function in accordance with some embodiments.

FIG. 2 is an illustration of a host communicating a synchronization signal to align a job submission from a virtual function with a time slice assigned to the virtual function in accordance with some embodiments.

FIG. 3 is an illustration of temporal partitioning of a parallel processor assigned to a plurality of virtual functions in accordance with some embodiments.

FIG. 4 is an illustration of cross-frame inconsistency in multiple virtual functions.

FIG. 5 is an illustration of cross-frame consistency in a parallel processor with job submissions from a virtual function aligned with time slices assigned to the virtual function in accordance with some embodiments.

FIG. 6 is a flow diagram illustrating a method for aligning job submissions from a virtual function with time slices assigned to the virtual function in accordance with some embodiments.

### DETAILED DESCRIPTION

The hardware resources of a parallel processor such as a GPU are partitioned according to SR-IOV among multiple virtual functions (VFs). Using temporal partitioning, a device scheduler (also referred to as a host driver) running with a host virtual machine or with a device micro-engine assigns a time slice to each of the multiple VFs during which the VF has exclusive access to the entire parallel processor. During the VF's time slice, the parallel processor executes commands (referred to herein as “jobs”) generated by a central processing unit (CPU) for an application executing on the guest operating system (OS) for the VF. When a VF's time slice expires, the VF is preempted and a scheduler initiates a world switch to transfer access to the parallel processor to the next VF. Typically, the time slice durations for each VF are equal to ensure fairness. However, because the VF's time slice is decoupled from the application's graphics rendering timing, the world switch could occur before the parallel processor has completed rendering a frame, in which case the parallel processor will only finish rendering the frame at the VF's next time slice. Such a delay can result in visual stuttering and lagging from a desired frame rate.

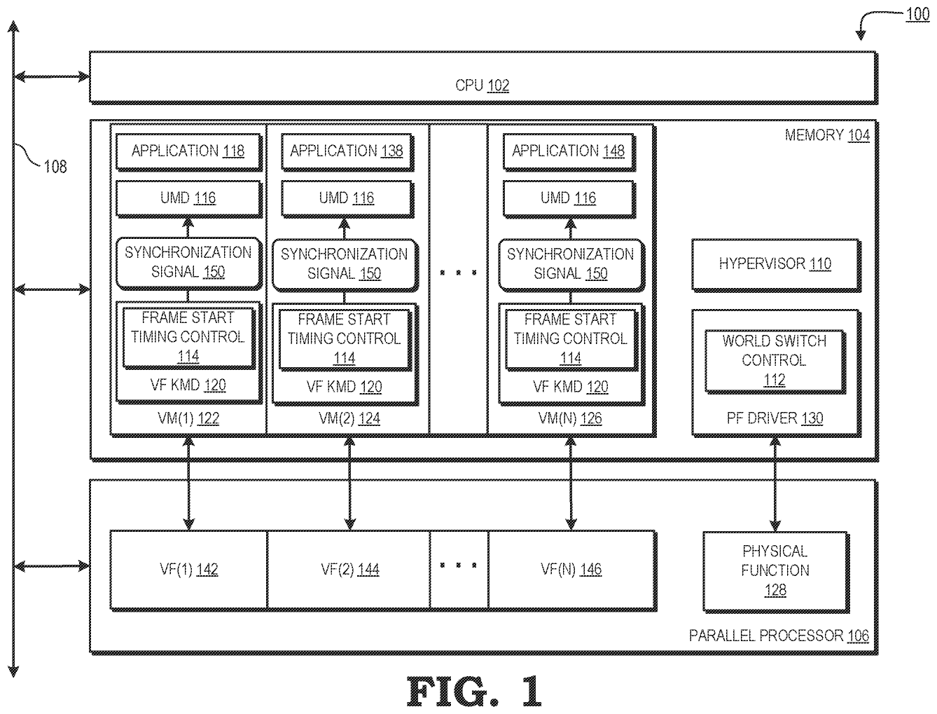

FIGS. 1-6 illustrate systems and techniques for aligning rendering timing of an application executing at a guest virtual function (VF) to world switch timing of a host virtual machine of a processing system. The physical function (PF) driver running in the host machine sets a world switch interval based on a number of VFs that share a parallel processor and a target maximum frame rate (in frames per second (fps)). The processing system delays submission of jobs for a VF to the parallel processor by an offset with respect to the world switch timing to ensure that the application starts generating a job for the parallel processor before the VF gains a time slice so the job will be ready for the parallel processor when the VF gains the time slice.

In some embodiments, the host PF driver assigns a time slice to a VF and sends a world switch signal indicating the start of the time slice to the VF. The guest VM's kernel mode driver calculates a delay to be applied before the application generates the next job on a CPU. Rather than let the application immediately start generating the next frame's rendering job, the application or application process's user mode driver delays the next frame's start until a signal is sent by the VM's kernel mode driver. Because it takes some time for the application to generate the rendering jobs, the signal is earlier than the next world switch. Accordingly, the timing of the signal is the previous world switch time plus a calculated delay, which is equivalent to the next world switch time minus a frame start latency, which is the time needed to generate the rendering job. In some embodiments, the delay is offset from the world switch timing by an amount based on a history of the amount of time needed to prepare a previous number of frames X submitted by the application executing at the VF (referred to herein as a history of job preparation durations). The number of frames X is programmable by a user in some embodiments.

For example, in some embodiments the job preparation durations are measured by a duration from a time that a CPU begins preparing commands for execution at the parallel processor until the commands are ready to be sent to the parallel processor, referred to herein as “job start latency”. Some applications experience variations between frames in job preparation durations. To account for such variations, in some embodiments, the delay is further based on a bias reflecting the amount of variation in job preparation durations for a previous M number of frames. In some embodiments, the number of frames M for determining the bias equals the number of frames X for purposes of determining the offset, and in other embodiments M differs from X.

The VM's kernel mode driver sends to a user mode driver in the application process or to the application itself (propagated to the application via the user mode driver) a signal indicating the application's frame start (i.e., when the application starts to generate rendering jobs for the next frame) that is delayed from the previous world switch, thus aligning the rendering timing of the application with the next world switch, allowing the application to begin preparing work for the parallel processor ahead of the world switch. By timing the signal by an offset and a bias, the guest VM's kernel mode driver accounts for a job preparation duration based on previous frames' job preparation durations and variations in previous frames' job preparation durations such that the work is likely to be ready for the parallel processor when the VF gains the next time slice.

FIG. 1 is a block diagram of a processing system 100 configured to align a job submission from a virtual function with a time slice assigned to the virtual function in accordance with some embodiments. The processing system 100 includes a central processing unit (CPU) 102 for executing instructions such as draw calls and a parallel processor 106 such as a GPU for performing graphics processing and, in some embodiments, general purpose computing. The processing system 100 also includes a memory 104 such as a system memory, which is implemented as dynamic random access memory (DRAM), static random access memory (SRAM), nonvolatile RAM, or other type of memory. The CPU 102, the parallel processor 106, and the memory 104 communicate over an interface 108 that is implemented using a bus such as a peripheral component interconnect (PCI, PCI-E) bus. However, other embodiments of the interface 108 are implemented using one or more of a bridge, a switch, a router, a trace, a wire, or a combination thereof. The processing system 100 is implemented in devices such as a computer, a server, a laptop, a tablet, a smart phone, and the like.

The CPU 102 executes processes such as one or more applications 118, 138, 148 that generate commands, user mode drivers 116, and other drivers. The applications 118, 138, 148 include applications that utilize the functionality of the parallel processor 106, such as applications that generate work in the processing system 100 or an operating system (OS). Some embodiments of the applications 118, 138, 148 generate commands that are provided to the parallel processor 106 over the interface 108 for execution. For example, the applications 118, 138, 148 can generate commands that are executed by the parallel processor 106 to render a graphical user interface (GUI), a graphics scene, or other image or combination of images for presentation to a user.

Some embodiments of the applications 118, 138, 148 utilize an application programming interface (API) (not shown) to invoke the user mode drivers 116 to generate the commands that are provided to the parallel processor 106. In response to instructions from the API, the user mode drivers 116 issue one or more commands to the parallel processor 106, e.g., in a command stream or command buffer. The parallel processor 106 executes the commands provided by the API to perform operations such as rendering graphics primitives into displayable graphics images. Based on the graphics instructions issued by applications 118, 138, 148 to the user mode drivers 116, the user mode drivers 116 formulate one or more graphics commands that specify one or more operations for the parallel processor 106 to perform for rendering graphics. In some embodiments, the user mode drivers 116 are provided by the parallel processor 106 hardware vendor. Each of the application 118, 138, 148's processes have an instance of user mode driver 116 which communicates with the guest operating system and kernel mode driver 120 (also referred to herein as a VF KMD 120) to utilize the parallel processor 106.

The processing system 100 comprises multiple virtual machines (VMs), VM(1) 122, VM(2) 124, . . . , VM(N) 126 that are configured in memory 104 on the processing system 100. Resources from physical devices of the processing system 100 are shared with the VMs 122, 124, 126. The resources can include, for example, a graphics processor resource from the parallel processor 106, a central processing unit resource from the CPU 102, a memory resource from memory 104, a network interface resource from a network interface controller, or the like. The VMs 122, 124, 126 use the resources for performing operations on various data (e.g., video data, image data, textual data, audio data, display data, peripheral device data, etc.). In one embodiment, the processing system 100 includes a plurality of resources, which are allocated and shared amongst the VMs 122, 124, 126.

The processing system 100 also includes a hypervisor 110 that is represented by executable software instructions stored in memory 104 and manages instances of VMs 122, 124, 126. The hypervisor 110 is also known as a virtualization manager or virtual machine manager (VMM). The hypervisor 110 controls interactions between the VMs 122, 124, 126 and the various physical hardware devices, such as the parallel processor 106. The hypervisor 110 includes software components for managing hardware resources and software components for virtualizing or emulating physical devices to provide virtual devices, such as virtual disks, virtual processors, virtual network interfaces, or a virtual parallel processor as further described herein for each virtual machine 122, 124, 126. In one embodiment, each virtual machine 122, 124, 126 is an abstraction of a physical computer system and may include an operating system (OS), such as Microsoft Windows® and applications, which are referred to as the guest OS and guest applications, respectively, wherein the term “guest” indicates it is a software entity that resides within the VMs.

The VMs 122, 124, 126 generally are instanced, meaning that a separate instance is created for each of the VMs 122, 124, 126. One of ordinary skill in the art will recognize that a host system may support any number N of virtual machines. As illustrated, the hypervisor 110 provides N virtual machines 122, 124, 126, with each of the guest virtual machines 122, 124, 126 providing a virtual environment wherein guest system software resides and operates. The guest system software includes application software and VF kernel mode drivers (KMDs) 120, typically under the control of a guest OS. The VF KMDs 120 control operation of the parallel processor 106 by, for example, providing an API to software (e.g., applications 118, 138, 148) executing on the CPU 102 to access various functionality of the parallel processor 106. It will be appreciated that although for the sake of simplicity each of the VF KMDs and each of the user mode drivers are referred to by the same reference number, the VF KMDs and user mode drivers are independent of each other.

In various virtualization environments, single-root input/output virtualization (SR-IOV) specifications allow for a single Peripheral Component Interconnect Express (PCIe) device (e.g., parallel processor 106) to appear as multiple separate PCIe devices. A physical PCIe device (such as parallel processor 106) having SR-IOV capabilities may be configured to appear as multiple functions. The term “function” as used herein refers to a device with access controlled by a PCIe bus. SR-IOV operates using the concepts of physical functions (PF) and virtual functions (VFs), where physical functions are full-featured functions associated with the PCIe device. A virtual function (VF) is a function on a PCIe device that supports SR-IOV. The VF is associated with the PF and represents a virtualized instance of the PCIe device. Each VF has its own PCI configuration space. Further, each VF also shares one or more physical resources on the PCIe device with the PF and other VFs.

In the example embodiment of FIG. 1, SR-IOV specifications enable the sharing of parallel processor 106 among the virtual machines 122, 124, 126. The parallel processor 106 is a PCIe device having a physical function 128. The virtual functions VF(1) 142, VF(2) 144, . . . , VF(N) 146 are derived from the physical function 128 of the parallel processor 106, thereby mapping a single physical device (e.g., the parallel processor 106) to a plurality of virtual functions 142, 144, 146 that are shared with the guest virtual machines 122, 124, 126. In some embodiments, the hypervisor 110 maps (e.g., assigns) the virtual functions 142, 144, 146 to the guest virtual machines 122, 124, 126. In another embodiment, the hypervisor 110 delegates the assignment of virtual functions 142, 144, 146 to a physical function (PF) driver 130 (also referred to as a host physical driver) of the parallel processor 106. For example, VF(1) 142 is mapped to VM(1) 122, VF(2) 144 is mapped to VM(2) 122, and so forth. The virtual functions 142, 144, 146 appear to the OS of their respective virtual machines 122, 124, 126 in the same manner as a physical parallel processor would appear to an operating system, and thus, the virtual machines 122, 124, 126 use the virtual functions 142, 144, 146 as though they were a hardware device. In some embodiments, the PF driver 130 is implemented at the hypervisor 110. In some embodiments, the PF driver 130 is implemented at the host kernel space or host user mode space (not shown).

Initialization of a VF involves configuring hardware registers of the parallel processor 106. The hardware registers (not shown) store hardware configuration data for the parallel processor 106. A full set of hardware registers is accessible to the physical function 128. The hardware registers are shared among multiple VFs 142, 144, 146 by using context save and restore to switch between and run each virtual function. Therefore, exclusive access to the hardware registers is required for the initializing of new VFs. As used herein, “exclusive access” refers to the parallel processor 106 registers being accessible by only one virtual function at a time during initialization of VFs 142, 144, 146. When a virtual function is being initialized, all other virtual functions are paused or otherwise put in a suspended state where the virtual functions and their associated virtual machines do not consume parallel processor 106 resources. When paused or suspended, the current state and context of the VF/VM are saved to a memory location. In some embodiments, exclusive access to the hardware registers allows a new virtual function to begin initialization by pausing other running functions. After creation, the VF is able to be directly assigned an I/O domain. The hypervisor 110 assigns a VF 142, 144, 146 to a corresponding VM 122, 124, 126 by mapping configuration space registers of the VFs 142, 144, 146 to the configuration space presented to the VM by the hypervisor 110. This capability enables the VF 142, 144, 146 to share the parallel processor 106 and to perform I/O operations without CPU 102 and hypervisor 110 software overhead.

In some embodiments, after a new virtual function finishes initializing, a world switch control 112 triggers world switches between all already active VFs (e.g., previously initialized VFs) which have already finished initialization such that each VF is allocated a time slice on the parallel processor 106 to handle any accumulated commands. In operation, in various embodiments, the world switch control 112 manages time slices for the VFs 142, 144, 146 that share the parallel processor 106. That is, the world switch control 112 is configured to manage time slices by tracking the time slices, stopping work on the parallel processor 106 when a time slice for a VF 142, 144, 146 that is being executed has expired, and starting work for the next VF 142, 144, 146 having the subsequent time slice. In the illustrated example, the world switch control 112 is implemented as part of the PF driver 130. In other embodiments, the world switch control 112 is implemented as part of the physical function 128 of the parallel processor 106.

To facilitate alignment of sending generated work for the parallel processor 106 for a VF 142, 144, 146 with the beginning of the VF's allocated time slice, the world switch control 112 is configured to assign time slices to the VFs 142, 144, 146 based on the number of VFs executing at the parallel processor 106 and the target frame rates of the applications 118, 138, 148. In addition, each VF KMD 120 includes a frame start timing control 114 configured to send a periodic synchronization signal 150 to the user mode driver 116 or to the application 118 (via the user mode driver 116), depending on which of the user mode driver 116 or the applications 118, 138, 148 implements the frame start control logic, indicating that the application 118, 138, 148 is to start generating a frame's rendering and then send accumulated commands for the frame for the VF 142, 144, 146 to the parallel processor 106.

In some embodiments, the periodic synchronization signal 150 is delayed from the start of the previous time slice by a calculated amount of time based on an offset and a bias. The offset is based on a history of job preparation durations of a previous user-programmable X number of frames submitted by the application 118 executing at the VF 142, 144, 146. The bias is based on the amount of variation in job preparation durations for a previous M number of frames. The periodic synchronization signal 150 allows the application 118 to align the rendering timing for the VF 142, 144, 146 with the world switch. By setting the delay between the start of the previous time slice and the periodic synchronization signal 150 based on the offset and the bias, the frame start timing control 114 predicts a job preparation duration such that the rendering job for a frame is likely to be ready for the parallel processor 106 when the VF 142, 144, 146 gains the next time slice.

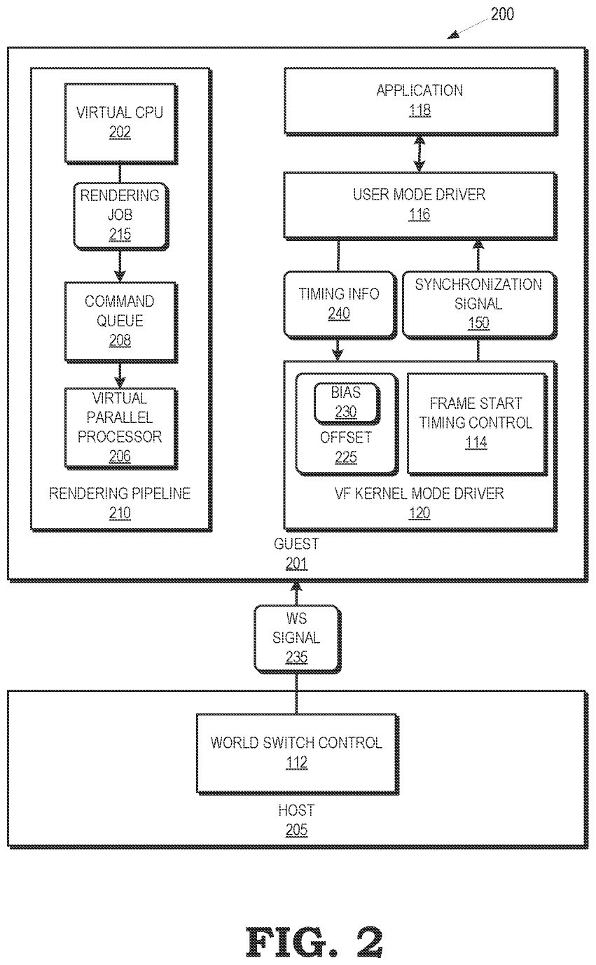

FIG. 2 is an illustration 200 of a virtual function kernel mode driver 120 communicating a periodic synchronization signal 150 to align a job submission from an application 118 executing at a virtual function VF(1) 142 with a time slice assigned to the VF(1) 142 in accordance with some embodiments. A host 205 includes the world switch control 112, which sends a world switch signal 235 to a guest 201 virtual machine. The guest 201 includes the CPU 102 and the parallel processor 106, which are partitioned into virtual functions during initialization of the physical function. In some embodiments, each of the virtual machines includes an application 118 such as a video game, an application programming interface (API), a user mode driver (UMD) 116, the VF kernel mode driver (KMD) 120, and a rendering pipeline 210 that includes a virtual CPU 202 and a virtual parallel processor 206. The host 205 implements a host operating system or a hypervisor 110 for the physical function. The hypervisor 110 launches one or more VMs such as VM(1) 122, VM(2) 124, . . . , VM(N) 126 for execution on a physical resource such as the parallel processor 106 that supports the physical function.

The VMs 122, 124, 126 are assigned to a corresponding virtual function such as VF(1) 142, VF(2) 144, . . . , VF(N) 146. The virtual functions 142, 144, 146 submit jobs to the parallel processor 106 which provides GPU functionality to the corresponding VMs 122, 124, 126. The virtualized parallel processor 106 is therefore shared across many VMs 122, 124, 126. Time slicing, also known as temporal partitioning, and context switching are used to provide fair access to the parallel processor 106 by the virtual functions 142, 144, 146 such that each of the virtual functions 142, 144, 146 are assigned respective time partitions for execution of a plurality of jobs by the parallel processor 106.

The world switch control 112 determines a world switch cycle interval between a VF's successive time slice beginnings. In some embodiments, the world switch control 112 defines the world switch cycle interval based on the target maximum frame rate in frames per second:

$$Interval = \frac{1}{Target FPS} = {\sum }_{i = 1}^{N} TimeSlice ( {VF}_{i} ) , i = 1 , ... , N$$

In some embodiments, the VFs are assigned equal time slices, such that

$$TimeSlice ( {VF}_{i} ) = \frac{1}{N \times TargetFPS} .$$

The world switch control 112 sends the world switch signal 235 to the VF KMD 120 to indicate the beginning of the world switch that starts the VF(1) 142's time slice.

In the illustrated example, the VF KMD 120 determines timing of the periodic synchronization signal 150 that signals the application 118 to instruct the CPU 202 to prepare a rendering job 215 for the next frame for the VF(1) 142. The frame start timing control 114 sets the timing of the periodic synchronization signal 150 in every world switch cycle as the previous world switch cycle's timing delayed by a calculated offset 225. By setting the timing to the previous cycle's world switch timing plus the offset, the frame start timing control 114 ensures that the application 118 starts generating the rendering job 215 earlier so that when the VF(1) 142 gains its next time slice, the rendering job 215 is ready to send to the parallel processor 206.

The offset 225 is based on a history of previous frames of the application 118. The offset 225 approximates world switch cycle interval minus the duration from the time the application 118 starts CPU work for a frame to the time when the graphics processing work is ready to send to the parallel processor 206, referred to as frame start latency. The application 118 communicates timing information 240 for each frame to the VF KMD 120. In some embodiments, the offset 225 is calculated as the world switch cycle interval minus average frame start latency for the previous X frames of the application 118 based on the timing information 240. In some embodiments, the number of previous frames X is a user-controlled parameter. If the offset 225 is too large, the execution start of the parallel processor 206 work could be delayed in the VF(1) 142's time slice, thus wasting time at the beginning of the VF(1) 142's time slice. Further, an offset that is too large could cause rendering to start too late such that the world switch preempts rendering of the frame before it is completed. If the offset 225 is smaller, the time slice cycle is not wasted, and the impact on frame latency is increased because the rendering job is being held until the VF(1) 142 gets the time slice. To prevent the offset 225 from becoming too large, in some embodiments the offset is reduced by a bias 230 based on a variability of frame start latencies for the previous M frames of the application 118. Thus, the offset 225 is calculated as

$$Offset = Interval - {Average}_{frame start latency of frame i} - {Bias}_{frame start latency of frame j}$$

where i=1, 2, . . . , X, j=1, 2, . . . , M, and X or M is the window size of frame history. In some embodiments, the bias 230 is a non-negative number based on the frame history, such as a fraction (e.g., 5%) of the average frame start latency. Thus, if the previous frames have a large variation in frame start latency, the bias will be larger (and the offset accordingly smaller) to allow more than average time for frame start latency.

In operation, the world switch control 112 determines the world switch interval and communicates the world switch signal 235 to the VF KMD 120. The user mode driver 116 communicates timing information 240 for each frame to the VF KMD 120. Based on the timing information 240, the VF KMD 120 calculates the offset 225. In some embodiments, the offset 225 is world switch cycle interval minus the average frame start latency for the previous X frames and minus the bias 230.

The frame start timing control 114 sends the periodic synchronization signal 150 to the user mode driver 116 indicating the application's frame start (i.e., when the application starts to generate rendering jobs for the next frame) for the VF(1) 142. In response to the periodic synchronization signal 150, the application 118 starts work at the virtual CPU 202 for the next frame. The virtual CPU 202 prepares the rendering job 215 for the virtual parallel processor 206 and places the rendering job 215 in a command queue 208 for the virtual parallel processor 206 at a time that aligns with the next world switch for the time slice assigned to the VF(1) 142.

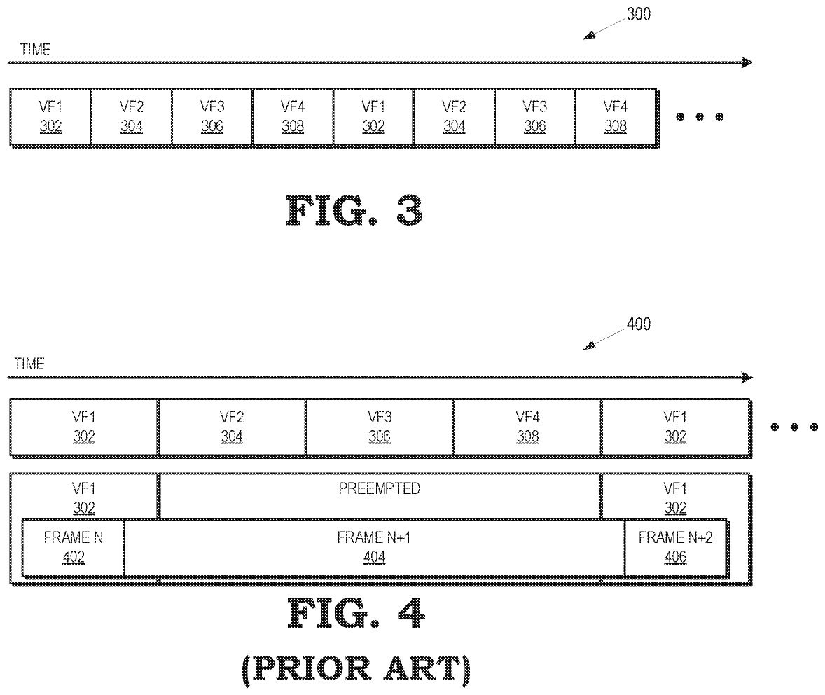

FIG. 3 is an illustration 300 of temporal partitioning of the parallel processor 106 assigned to a plurality of virtual functions in accordance with some embodiments. The world switch control 112 assigns time slices to the virtual functions based on the number of VFs executing at the parallel processor 106 and the target frame rates of the applications 118. In the illustrated example, the world switch control 112 assigns time slice 302 to VF1, time slice 304 to VF2, time slice 306 to VF3, and time slice 308 to VF4. The time slices 302, 304, 306, 308 repeat periodically. In some embodiments, to ensure fairness, the world switch control 112 assigns equal time slices to each of the virtual functions.

FIG. 4 is an illustration 400 of cross-frame inconsistency in multiple virtual functions. In the absence of a periodic synchronization signal 150, the frame start latency is not aligned with the time slices allocated to each virtual function. In the illustrated example, each of VF1, VF2, VF3, and VF4 are assigned equal time slices on the parallel processor 106. The application 118 running in VF1 generates consistent graphics processing workloads across frames and would have a stable frame rate if it were running on a single parallel processor configuration. However, with temporal partitioning of the parallel processor 106, each frame's rendering time at the parallel processor 106 is slightly shorter than the VF1's time slice 302. Therefore, when the parallel processor 106 completes rendering frame N 402, there is enough time for the parallel processor 106 to start rendering frame N+1 404 within the time slice 302, but not enough time for the parallel processor 106 to complete rendering the frame N+1 404 during the left over time in time slice 302.

Before the parallel processor 106 has completed rendering frame N+1 404, VF1 is preempted by the world switch and the parallel processor 106 is not able to complete rendering frame N+1 404 until the VF1 regains the time slice 302 after time slices 304, 306, and 308 have been used by VF2, VF3, and VF4, respectively. The parallel processor 106 then renders frame N+2 406 in the same time slice 302 in which it completes rendering frame N+1 404. Thus, there is a large variation in frame rates across frames N 402, N+1 404, and N+2 406. Such large cross-frame variation in frame rates can cause problems such as visual stuttering, long and irregular lagging, and reduced frame rate, all of which can negatively impact the user experience.

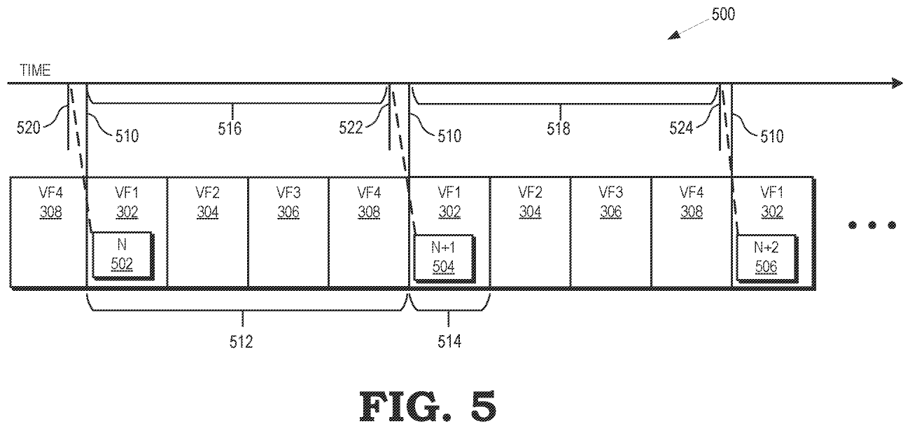

FIG. 5 is an illustration 500 of cross-frame consistency in a parallel processor 106 with job submissions from a virtual function VF1 aligned with time slices 302 assigned to the virtual function VF1 in accordance with some embodiments. The world switch control 112 sets an interval 512 for the world switch cycle having a duration that is based on the number of virtual functions executing at the parallel processor 106 and the target maximum frame rate for applications 118 executing at the virtual functions VF1, VF2, VF3, VF4. In the illustrated example, the world switch control 112 assigns a time slice 302 to VF1, a time slice 304 to VF2, a time slice 306 to VF3, and a time slice 308 to VF4. Each of the time slices 302, 304, 306, 308 has a duration 514 that is 1/(4*target frame rate).

The world switch that begins the time slice 302 assigned to VF1 occurs at a time 510. Thus, at time 510, the host 205 sends a world switch signal 235 to the VF KMD 120 indicating the world switch. To align the frame start with the world switch, the application 118, or the application user mode driver 116, holds the frame start until the VF KMD 120 sends the periodic synchronization signal 150. The periodic synchronization signal 150 is delayed from the time 510 previous world switch by an offset 225. In some embodiments, the offset 225 is world switch cycle interval minus an average of the frame start latency of the previous X frames, and the bias 230 is a non-negative number based on the variation in frame start latencies of the previous M frames. The delay is calculated in every world switch cycle.

In the illustrated example, at a time 520 before the time 510 of the world switch signal 235, the VF KMD 120 sends a periodic synchronization signal 150 to the user mode driver 116 indicating the frame start. In response to the periodic synchronization signal 150, the application 118 starts its CPU work for frame N 502. By starting the CPU work for the frame N 502 prior to the world switch at time 510, the graphics processing work for the frame N 502 is ready to start at or soon after VF1 gains the time slice 302. Accordingly, the parallel processor 106 completes rendering the frame N 502 within the time slice 302.

A delay 516 separates the time of the next periodic synchronization signal 150 at a time 522 from the time 510 of the previous world switch. At time 522, the VF KMD 120 sends the next periodic synchronization signal 150 to the user mode driver 116 indicating the frame start. In response to the periodic synchronization signal 150, the application 118 starts CPU work for the frame N+1 504. The graphics processing work for the frame N+1 504 is ready to start at or soon after VF1 gains the next time slice 302, and the parallel processor 106 completes rendering the frame N+1 504 within the time slice 302.

A delay 518 separates the time of the next periodic synchronization signal 150 at a time 524 from the time 510 of the previous world switch. At time 524, the VF KMD 120 sends the next periodic synchronization signal 150 to the user mode driver 116 indicating the frame start. In response to the periodic synchronization signal 150, the application 118 starts CPU work for the frame N+2 506. The graphics processing work for the frame N+2 506 is ready to start at or soon after VF1 gains the next time slice 302, and the parallel processor 106 completes rendering the frame N+2 506 within the time slice 302. By adjusting the delays 516, 518 based on the average frame start latency and variations in frame start latency (i.e., bias) of previous frames, the VF KMD 120 aligns graphics rendering with world switches to achieve reduced visual stuttering and lagging at the desired frame rate.

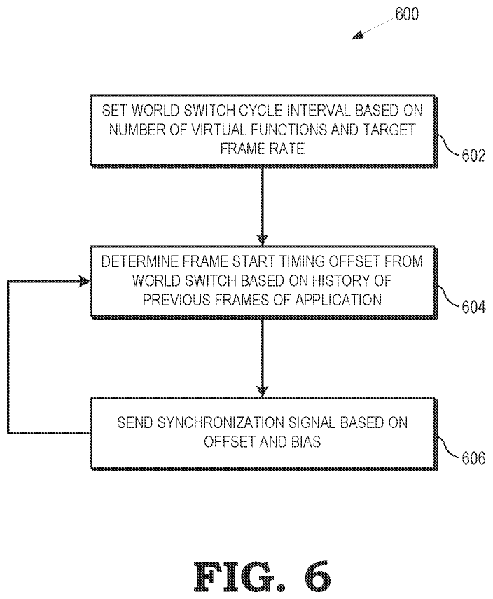

FIG. 6 is a flow diagram illustrating a method 600 for aligning job submissions from a virtual function with time slices assigned to the virtual function in accordance with some embodiments. Although the operations of FIG. 6 are described with respect to the system of FIGS. 1-2, it should be appreciated that the method 600, performed by any like system, with steps as illustrated or any other feasible order, falls within the scope of the present disclosure.

The method flow begins at block 602, at which the world switch control 112 sets the world switch cycle interval based on the number of virtual functions initialized at the parallel processor 106 and the target frame rate of the application(s) 118.

At block 604, the VF KMD 120 calculates the frame start timing offset 225 from the world switch based on a history of frame start latencies of previous frames of the application 118. In some embodiments, the application 118 or the application process's user mode driver 116 provides each frame's timing information to the VF KMD 120. In some embodiments, the offset 225 is based on an average of frame start latencies for a previous X frames, where X is a user-controlled parameter, and a frame start timing bias 230 based on a variability in frame start latencies for a previous M frames, where M is a user-controller parameter that is equal to X in some embodiments and is greater than or less than X in other embodiments. The bias is a non-negative number based on the frame history such as a fraction (e.g., 5%) of the average frame start latency. Thus, in some embodiments, the offset is world switch cycle interval minus the average frame start latency and minus the bias.

At block 606, the VF KMD 120 sends the periodic synchronization signal 150 to the application 118 at a delay 516, 518 from the world switch timing 510 based on the world switch signal and the offset indicating the frame start. In response to the periodic synchronization signal 150, the application 118 starts its CPU work for a frame such as frame N 502 so the graphics processing work for the frame N 502 will be ready to send to the parallel processor 106 when the VF1 gains the time slice 302 at the time 510 next world switch. The method flow then continues back to block 604 for the next frame.

In some embodiments, the apparatus and techniques described above are implemented in a system including one or more integrated circuit (IC) devices (also referred to as integrated circuit packages or microchips), such as the processing system described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
assigning, at a host executing at a parallel processor, a time slice to a first virtual function of a plurality of virtual functions; and
sending a signal from a kernel mode driver to a user mode driver for the first virtual function, wherein the signal indicates when an application executing at the first virtual function is to start generating rendering jobs for a next frame.

2. The method of claim 1, wherein
assigning the time slice is based on a number of the plurality of virtual functions and a target frame rate of the application executing at the first virtual function.

3. The method of claim 1, further comprising:
calculating a delay between consecutive time slices assigned to the first virtual function; and
sending the signal based on the delay.

4. The method of claim 1, wherein sending the signal is at an offset from a world switch between a first time slice assigned to the first virtual function and a second time slice assigned to a second virtual function.

5. The method of claim 4, wherein the offset is based on a history of job preparation durations for previous frames submitted by an application executing at the first virtual function to the parallel processor.

6. The method of claim 5, wherein the job preparation durations are measured by a job start latency, the job start latency comprising a duration from a first time of a start of work at a central processing unit (CPU) for a frame to a second time when work for the frame is ready to be sent to the parallel processor.

7. The method of claim 5, wherein a number of previous frames included in the history of job preparation durations is set by a user.

8. The method of claim 5, wherein the offset is further based on a bias reflecting a variation in job preparation durations between frames submitted by the application.

9. A method, comprising:
setting a world switch between a first time slice assigned to a first virtual function of a plurality of virtual functions and a second time slice assigned to a second virtual function of the plurality of virtual functions based on a target frame rate for applications executing at the first virtual function and the second virtual function and a number of the plurality of virtual functions; and
aligning submission of a job from the first virtual function to a parallel processor with a start of the first time slice.

10. The method of claim 9, wherein aligning comprises:
sending a signal indicating when an application executing at the first virtual function is to begin generating rendering jobs for a next frame.

11. The method of claim 10, further comprising:
calculating a delay between consecutive time slices assigned to the first virtual function; and
sending the signal based on the delay.

12. The method of claim 10, wherein sending the signal is at an offset from the world switch.

13. The method of claim 12, wherein the offset is based on a history of job preparation durations for previous frames submitted by the application executing at the first virtual function to the parallel processor.

14. The method of claim 13, wherein the job preparation durations are measured by a job start latency, the job start latency comprising a duration from a first time of a start of work at a central processing unit (CPU) for a frame to a second time when work for the frame is ready to be sent to the parallel processor.

15. The method of claim 13, wherein a number of previous frames included in the history of job preparation durations is set by a user.

16. The method of claim 13, wherein the offset is further based on a bias reflecting a variation in job preparation durations between frames submitted by the application.

17. A device, comprising:
a memory; and
a parallel processor configured to:
assign a time slice to a first virtual function of a plurality of virtual functions; and
send a signal indicating when an application executing at the first virtual function is to begin generating rendering jobs for a next frame.

18. The device of claim 17, wherein the time slice is based on a number of the plurality of virtual functions and a target frame rate of the application.

19. The device of claim 17, wherein the parallel processor is configured to send the signal at an offset from a world switch between a first time slice assigned to the first virtual function and a second time slice assigned to a second virtual function.

20. The device of claim 19, wherein the offset is based on a history of job preparation durations at a central processing unit for previous frames submitted by the application to the parallel processor and a bias reflecting a variation in job preparation durations between frames submitted by the application.
